(19) United States
(12) Patent Application Publication
(10) Pub. No.: US 2004/0002893 A1
(43) Pub. Date: Jan. 1, 2004

(54) System and method for customer relationship management

(76) Inventor: Ivan Art Feher, Lackawaxen, PA (US)

Correspondence Address: Andrew C. Greenberg, Esquire, Carlton Fields, P.A., P.O. Box 3239, Tampa, FL, 33601-3239, US

(21) Appl. No.: 10/426,199

(22) Filed: Apr. 30, 2003

Related U.S. Application Data
(60) Provisional application No. 60/376,453, filed on Apr. 30, 2002.

(51) Int. Cl. G06F 17/60

(52) U.S. Cl. 705/10; 705/11

(57) ABSTRACT

A method and apparatus for a method for customer relationship management is provided. The method entails gathering of customer information from various sources and entering same into a database. The data applied to a process matrix and sorted. An exit poll is administered and a balanced scorecard evaluation is applied. Dissatisfied customers are handled through various means and the information is fed back tin the customer relationship database.

### RELATED APPLICATIONS

This application claims priority from Provisional U.S. Patent Application entitled SYSTEM AND METHOD FOR CUSTOMER RELATIONSHIP MANAGEMENT, Ser. No. 60/376,453, filed Apr. 30, 2002, which is incorporated herein by reference and attached hereto as Exhibit “A”.

### TECHNICAL FIELD OF INVENTION

A system and method is disclosed for customer relationship management; particularly in the areas of sales force automation, database integration, and process fulfillment in the sale of new and used automobiles.

### BACKGROUND OF THE INVENTION

This invention relates generally to customer relationship management, and more particularly to a method for using and managing customer relationship information in the new and used car dealership industry.

At a high level, the problem all dealerships face is how to increase sales of new and used cars. Overall demand for cars in the economy and in a given region is driven mainly by broad demographic factors, including employment, age of population, and so on. Competition is mainly among dealerships for market share. Most dealers use, basically, the following steps: (i) rely on national, manufacturer-supplied advertising to promote interest in the dealer's brand(s) among those looking to purchase a vehicle; (ii) undertake extensive local radio, TV, and print advertising for the dealership to ensure that those interested are aware of the specific dealership; (iii) undertake some direct mail to existing (recent) customers of the dealership to follow up on such customers. Some individual dealers make an effort to follow up with customers, often by means of recommended service reminders and promotions. At least one manufacturer, Toyota, sends customer satisfaction surveys to some fraction of new and service customers.

Presently, there exist two primary vendors who provide management information systems to the automobile dealership industry. These systems are closed proprietary systems, most versions of which make it difficult or impossible to send out a simple follow up letter. There presently exists no system that is able to efficiently converge customer touch points. The existing systems do not allow for importing third party databases for action. Additionally, some existing systems actually delete vital deal-specific customer relations data after 90 days.

Although the existing automotive customer relations management providers have offered solutions: client server architecture or one-dimensional web sites, costs for initial set up can run tens of thousands of dollars, which can translate to almost $100.00 per customer tracked. The mass mailing services offered are premium services and can take up to eight weeks to produce. Furthermore, current software offerings are bloated solutions that tie automotive clients to lengthy and costly contracts. The dealer commitment includes both hardware and software purchases.

Current solutions are failing because of their legacy infrastructure, high investment requirements, slow response times to rapidly changing competitive environments, and omitted consideration of the business process. By not properly addressing the business process, solution providers do not have a viable mechanism to set performance criteria and accountability metrics or the requisite reward system that supports the process. In contrast, the instant invention focuses on the process. The process is the message, and may be based on our template model or the vision of the client.

Another problem with the prior art is that it is based on closed architectures intended to tie dealers indefinitely to legacy systems. These types of products do not adequately address the solutions offered in the instant invention, such as accountability metrics.

The instant invention provides almost instantaneous deployment that can be free or cost as little as $60.00 per month. Greater efficiency and return on investment will be realized because of the low cost of implementation. The solution does not require special hardware, software, or training while improving enterprise performance through set process adherence, validation and accountability.

Within the specific field of automotive dealership customer relationship management there are two main suppliers: Reynolds and Reynolds, and ADP. Both of their solutions suffer from serious flaws.

Reynolds and Reynolds offers almost 80 separate products and consulting services to support them. Their approach is to tie dealerships to lengthy contracts for the purchase of hardware and software. ADP is a management information system (MIS) provider that features 20 year old technology unable to effectively meet dealership and customer needs. CRM solution providers such as Autotown and Higher Gear offer one dimensional solutions that do not feature full CRM functionality or address a dealer's processes Also, these CRM providers, also offer closed proprietary systems and are not scalable just like Reynolds and Reynolds and ADP.

There are two key difficulties with the Reynolds and Reynolds and ADP solutions. First is cost. When a dealership has to spend a great deal of money to implement a customer relationship management solution, it will be reluctant to do so. Second is flexibility. As noted above, the most relevant competition in the automobile industry is dealership-to-dealership competition for market share in a given area; i.e., dealers competing against each other for the same pool of customers. A particular dealership's customer relationship management needs will, therefore, vary as other competing dealerships implement different strategies to attract customers. A long-term solution to dealership customer relationship management needs, therefore, will have to be flexible, allowing the dealership to vary its activities as its competitive environment changes. In summary, bloated solutions offered by ADP and R and R are not efficient customer relationship management delivery vehicles. And CRM companies like Autotown and Higher Gear are one dimensional, do not address processes and are closed systems; that are not scalable.

Several shortcomings with existing solutions are noted above. In addition, dealership need to focus on the customer relationship management process. Reynolds and Reynolds and ADP are more focused on continuing use of its legacy MIS infrastructure. No vendor is flexible in allowing dealerships to modify the systems to their sales forces based on changing circumstances.

What has been lacking in the past, and what is lacking from both Reynolds and Reynolds and ADP, is a systematic way to make use of available information and computer/communications technology to allow a dealership to effectively implement and monitor the sales/customer relationship management process and so distinguish a dealership from its competitors. Also, neither solution is open or scalable. Therefore, they do not allow for the implementation of best of class, third-party software, practices, tools and services.

### SUMMARY OF THE INVENTION

The present invention is a method and system for managing customer relations with respect to the automobile sales industry that utilizes a software-based approach to gather information through a variety of media to improve automobile dealership customer satisfaction and performance. Further, the instant system incorporates the use of Balanced Scorecard evaluations, polls, and sweepstakes to gather information regarding past, current, and potential customers. Additionally, the method and system incorporates exit polls to obtain information from non-customers to assess why those customers did not make purchases.

### BRIEF DESCRIPTION OF THE DRAWINGS

A particularly preferred embodiment of the invention of this apparatus will be described in detail below in connection with the drawings in which:

FIG. 1 is a schematic diagram depicting the method for carrying out customer relationship management processes in accordance with the present invention.

### DESCRIPTION OF PREFERRED EMBODIMENTS

Detailed Description of the Invention

It should be noted in discussing below the making and using of the different embodiments of the instant invention, that there are many embodiments using the inventive concepts of the instant invention. As such, the embodiments discussed herein are not to be construed as limiting the scope of the invention, but merely as illustrating several possible embodiments.

The preferred embodiment uses a variety of data-input devices to collect past, current, and potential customer data. Among the methods may be data collected via customer service representative on the telephone 10, or via a customer service web site 10; data already stored on an existing customer relationship management infrastructure, such as Reynolds and Reynolds 20; data gathered via sweepstakes kiosk 30; data obtained from a dealer web site 40, a third party web site 50, or a third party database 60.

Once the data is collected, it is input into the customer relationship management software. This software can be implemented using commercial customer relationship management software as a base. For example, the product offered by salesforce.com (www.salesforce.com) would appear to be acceptable. Information about particular actual and potential customers would be obtained from the various sources indicated in the small boxes above the main flow chart.

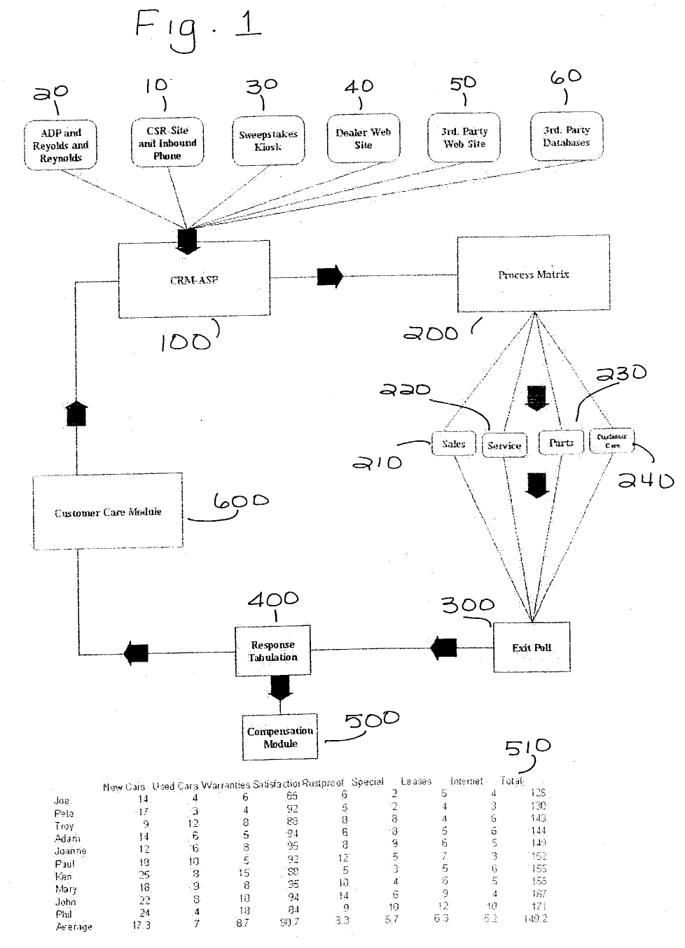

Referring to FIG. 1, customer information 10, 20, 30, 40, 50, 60 available from the pre-existing franchise information systems are extended into a consolidated customer relationship management database 100. Relevant fields are mined from the respective data sources and exported for action within the customer relationship management, ASP model 100.

Information from the dealership's contracted or in house customer service representative (CSR) 10, as well as all inbound telephone calls or web inquiries to the dealership, are extended.

Sweepstakes kiosk 30 represents a novel means of obtaining information about potential customers. The dealership would contract with local shopping malls and other appropriate locations to place internet kiosks that invite passers-by to enter a sweepstakes for a new car in exchange for providing some basic information (name, address, etc.) relevant to the person's automobile needs. One in some appropriately large number of entries would win a new car, and information from all entrants would become part of the customer relationship management database. The sweepstake and kiosk format would use the doubleclick.com proprietary software that is currently being utilized only by web sites http://www.doubleclick.net/us/corporate/privacy/privacy/sweepstakes.asp. This application would extend to brick and mortar entities. In addition to placing kiosks in malls and other public forums, kiosks would also be located in the automotive showroom, service, and parts departments. Smart cards may also be utilized in conjunction with the kiosk by charging the card with bonus points each time an existing or new customer logs on. Bar Code and Magnetic Card Readers can capture customer information from drivers licenses to be input into the CRM Database.

Dealer Web Site 40 are customer information data from the dealer's web site regarding people who respond to an invitation to provide such information. Customer prospects that make inquiries for pricing or specifications on new vehicles, service, or parts would also be a source of customer information.

3rd Party Web Site 50 are customer information data from third party web sites whose demographics indicate a reasonable likelihood of interest in purchasing a new car. This refers to subscription sites such as Autoweb or manufacturer's sites like Toyota, Honda, Chevrolet, Pontiac, or other automobile makers. These sites are additional sources that provide dealerships with leads.

3rd Party database 60 are customer information data directly obtained from third party marketing databases. Ideally, these databases will include information from an appropriate, relatively “localized” third party database, so that the dealership will have some basic information about potential customers who come to the dealership, even if those potential customers have not provided any information at all. These third party databases include companies such as www.polk.com that provide dealerships with databases that they have refined, filtered, or applied a predictive modeling matrix to better equip the dealer with targeting information. This refined database after importation into the consolidated customer relationship management/ASP 100 will be used for direct mail and/or phone campaigns. Again, the consolidated customer relationship management/ASP 100 will provide the platform for the process delivery. Also manufacturer sites like Toyota, Honda, Chevrolet, Pontiac, or other automobile makers provide data regarding customer satisfaction survey metrics that can be used for follow-up.

The information from the consolidated customer relationship management module (CRM-ASP) 100 is fed into a Process Matrix 200. The process matrix 200, initially a manual function for dealership management, takes this information and uses it in each of the functional areas of an automobile franchise (sales 210, service 220, parts 230, customer care 240). At a minimum, the personnel involved in each functional area will have the advantage of knowing some basic facts about the people with whom they are dealing. Any special concerns or information relating to a customer (e.g., long-time repeat customer; has referred others; unsatisfactory sales/service experience in recent past; credit-impaired) would be made available as well. To the extent that analysis of information in the customer relationship management module indicates that the dealership needs to stress particular areas of the customer contact process, this would also be indicated in the “Process Matrix.” The Process Matrix refers to the process each employee must follow. This is in the form of an A to Z or 1 to 12 step-by-step map. Sales, service, and parts personnel may share functions such as greet and meet but may differ in how they qualify customers as to their needs.

Every customer and potential customer interacting with the dealership would be asked to fill out a brief exit poll 300 regarding his or her experience with the dealership. Ideally, this would be done at a kiosk in the dealership and automatically input into the customer relationship management module, although manual polls are also possible. The questions in the exit poll would vary over time to reflect the areas that management has chosen to stress for improvement and reward in the process matrix 200 based on information from consolidated data in the customer relationship management (CRM-ASP) module 100. An important facet of this process is to assess the experiences not only of people who do business with the dealership (e.g., who come in and buy a car or have a car serviced) but also those who come in and then leave without doing business for some reason. The exit poll may be by means of the kiosk or a mailer, web or phone survey.

Response tabulation 400 converts the raw data from the exit poll 300 to a usable format. This process can be manual or computerized.

The compensation module 500,utilizing the survey response data, becomes just one of the component in the linked Balanced Scorecard(s) 510 that “scores” overall enterprise performance against set goals. This part of the process is supported by a management methodology, Balanced Scorecard Collaborative, located on the Internet at www.bscol.org. The scoring of the balanced scorecard 510 will be modified with some regularity to reflect performance results as well as changes in corporate strategy. The Balanced Scorecard (and compensation) will align the organization to the strategy as a continual process.

Information from the exit polls 300 is fed to the consolidated customer relationship management database 100 and also to a separate customer care module. Customers who have just made significant purchases will receive follow-up letters, thank-you gifts, or other correspondence to reflect follow-up. Customers whose exit polls 300 indicate a less-than-positive experience may be followed up in order to better understand problems and provide ideas for appropriate damage control.

Finally, all relevant information gleaned from the customer care process will be entered in the Balanced Scorecard module and also entered into the customer care module 600, thereby closing the loop on the ongoing process of gaining information about actual and potential customers, modifying dealership processes in order to reflect the information gained, evaluating and compensating dealership personnel based on that information, and thereby modifying dealership behavior and improving results with customers.

While the foregoing describes particularly preferred embodiments of the method and apparatus of this invention, it is to be understood that these embodiments are illustrative only of the principals of this invention and are not to be considered limitative thereof. Because numerous variations and modification of the apparatus and method of this invention will readily occur to those skilled in the art, the scope of this invention is to be limited solely by the claims appended hereto.

What is claimed is:

1. A method for using and managing customer relationship information in the new and used automobile dealership industry comprised of the steps of:
consolidating customer information from incoming telephone calls, sweepstakes kiosks, automobile dealer web sites, third-party web sites, third-party databases, and existing customer relationship management databases;
entering and storing said past, current, and potential customer information into a consolidated customer relationship management database;
entering said customer information from said consolidated commercial customer relationship management database into a process matrix;
sorting said customer information based on user-defined criteria;
administering an exit poll to discern each potential or actual customer's experience;
computing a balanced scorecard method evaluation of performance;
adding additional customer relationship information to said consolidated customer relationship management database as it becomes available;
using sweepstakes to obtain customer information; and
using said customer information to generate direct mailings and thank you cards.
